(19) United States
(12) Patent Application Publication
(10) Pub. No.: US 2018/0067568 A1
(43) Pub. Date: Mar. 8, 2018

(54) Computer Mouse Moving Device

(71) Applicant: David Thomas Beck, Kensington, MD (US)

(72) Inventor: David Thomas Beck, Kensington, MD (US)

(21) Appl. No.: 15/257,651

(22) Filed: Sep. 6, 2016

(51) Int. Cl. G06F 3/0354

(52) U.S. Cl. CPC G06F 3/03543; G06F 3/03549

(57) ABSTRACT

A computer mouse moving device includes a housing having an upper surface of a size sufficient to support a computer mouse, a movable element adjacent to the upper surface, a motor coupled to the movable element, and a controller for activating the motor at a recurring time interval. A motion sensing element on the computer mouse may detect the motion of the movable element and move a cursor on a user's computer, thereby preventing the user's computer from shutting down, entering a sleep mode, and/or logging out the user, even though the user is not present at the computer at the time.

### BACKGROUND

Computer settings are sometimes configured such that the computer will shut down, enter a sleep mode, and/or log out a user if the computer does not receive user input, for example, in the form of a key stroke or mouse movement, during a predetermined period. Computer users may find these settings inconvenient if they are going to be away from their computer for longer than the predetermined period, yet may be unable to change the computer settings, for various reasons. Computer users may desire to prevent their computers from shutting down, entering a sleep mode, and/or logging out the user even though the user will not be present at the computer to provide input during the predetermined period.

### SUMMARY

According to some possible implementations, a computer mouse moving device includes a housing having an upper surface of a size sufficient to support a computer mouse, a movable element adjacent to the upper surface, a motor coupled to the movable element, and a controller for activating the motor at a recurring time interval.

According to some possible implementations, a method of moving a computer mouse includes placing the computer mouse onto an upper surface of a mouse moving device, and activating a motor in the mouse moving device such that the motor moves a movable element adjacent to the upper surface to activate a motion sensor element on the computer mouse at a recurring time interval.

According to some possible implementations, a computer mouse moving device includes a housing having an upper surface, wherein the upper surface is of a size sufficient to support a computer mouse, a display element adjacent to the upper surface, and a controller coupled to the display element for causing the display element to display a moving visual pattern at a recurring time interval.

### BRIEF DESCRIPTION OF THE DRAWINGS

FIG. 1 is a diagram of an example implementation of a mouse moving device described herein;

FIG. 2 is a diagram of an example implementation of a mouse moving device described herein;

FIG. 3 is a diagram of an example implementation of a mouse moving device described herein;

FIG. 4 is a diagram of an example implementation of a mouse moving device described herein;

FIG. 5 is a diagram of an example implementation of a mouse moving device described herein;

FIG. 6 is a diagram of an example implementation of a mouse moving device described herein.

### DETAILED DESCRIPTION

The following detailed description of example implementations refers to the accompanying drawings. The same reference numbers in different drawings may identify the same or similar elements.

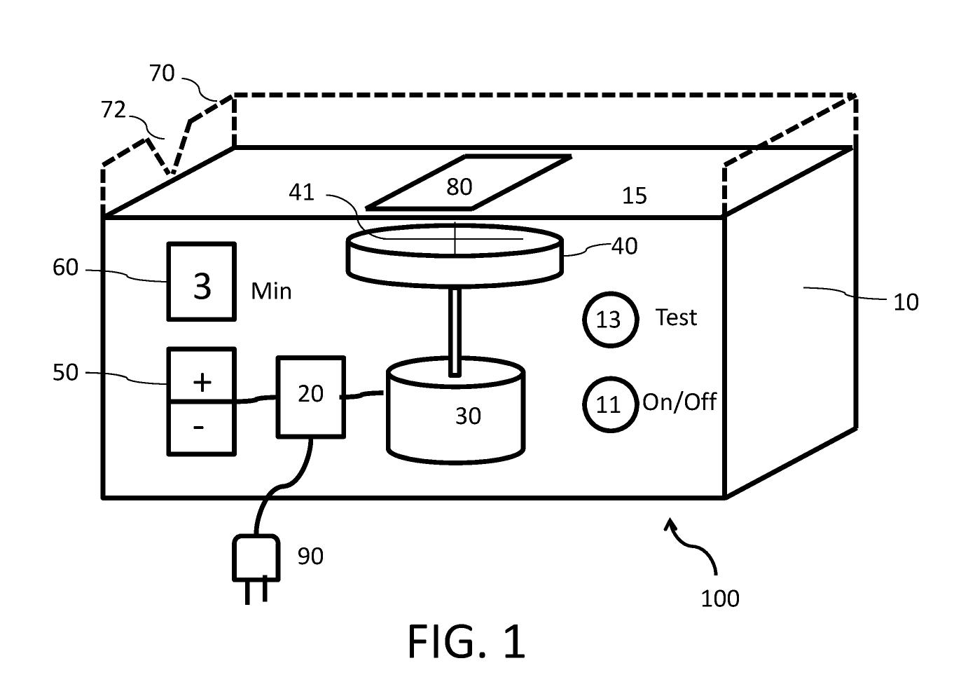

FIG. 1 is a diagram of an example implementation of a mouse moving device 100 described herein. As shown in FIG. 1, the mouse moving device 100 includes a housing 10 that includes an upper surface 15. The upper surface 15 has a size sufficient to support a computer mouse. The upper surface 15 may include a railing 70 for keeping a computer mouse in place on top of the upper surface 15. The railing 70 may completely surround the upper surface 15, although one side of the railing 70 has been omitted from the illustration shown in FIG. 1 for clarity. Alternatively, the railing may surround only portions of the upper surface 15. The railing 70 may include a cutout 72 to accommodate a cord of a computer mouse. The cord of a computer mouse may pass through the cutout 72 so that the computer mouse may sit flat on the upper surface 15.

The mouse moving device 100 includes a movable element 40. In the mouse moving device 100 of this example implementation, the movable element 40 is a wheel. The movable element 40 is arranged adjacent to the upper surface 15 and is visible through a window 80.

The movable element 40 is coupled to a motor 30 that moves the movable element 40. In one example, the motor 30 rotates the movable element 40. In another example, the motor 30 vibrates the movable element 40. In another example, the motor 30 moves the movable element 40 in one direction and then moves the movable element 40 in another direction. In another example, the motor 30 rotates the movable element 40 in one direction, for example, clockwise or counterclockwise, and then rotates the movable element 40 in the opposite direction.

The mouse moving device 100 may include a controller 20 that activates the motor 30 to move the movable element 40 at a recurring time interval. The controller 20 may move the movable element 40 for a predetermined time period and then stop moving the movable element 40, for example, the controller may move the movable element 40 for a predetermined time period of 1, 2, 3, 4, 5, 6, 7, 8, 9, or 10 seconds, or more. In one example, the controller 20 may cause the motor 30 to rotate the movable element 40 in a first direction for a first predetermined time period and then rotate the movable element 40 in a second direction for a second predetermined time period. The predetermined time periods may have the same or different durations. In one example, a user may be able to adjust the predetermined time period.

The mouse moving device 100 may include a control 50 for adjusting the length of the recurring time interval. For example, the control 50 may be used to program the controller 20 to adjust the number of minutes for the length of the time interval between when the motor 30 moves the movable element 40. The mouse moving device 100 may include a display 60 that displays the length of the recurring time interval. In one example, the length of the recurring time interval may be adjusted in minutes, for example, from between one minute to nine minutes. In another example, the length of the recurring time interval may be adjusted in minutes from between 1 and 60 minutes.

The mouse moving device 100 may include a testing control 13 for causing the motor 30 to activate the movable element 40 at a time other than the recurring time interval. This may allow a user to test that a computer mouse is properly seated on the mouse moving device 100 and give a user confidence that the mouse moving device 100 will move the computer mouse properly at the recurring time interval without waiting for that time interval to occur. The mouse moving device 100 may include an on/off switch 11 for turning the mouse moving device 100 on and off. In on example, the mouse moving device 100 may move the movable element 40 immediately upon being turned on and begin the recurring time intervals thereafter.

The movable element 40 may include a visual pattern 41 to ensure that an optical mouse will easily detect the movable element 40 when it is moving and cause the computer cursor to move. The visual pattern 41 may be a series of lines, a grid, a swirl, or other patterns. The visual pattern 41 may include high contrast colors that are easily detectable by an optical mouse.

The mouse moving device 100 includes a connection 90 to a power supply. The connection 90 may be a plug suitable for connecting to an electrical outlet to supply alternating current to the mouse moving device 100. The connection 90 may be a battery power supply located within the mouse moving device 100.

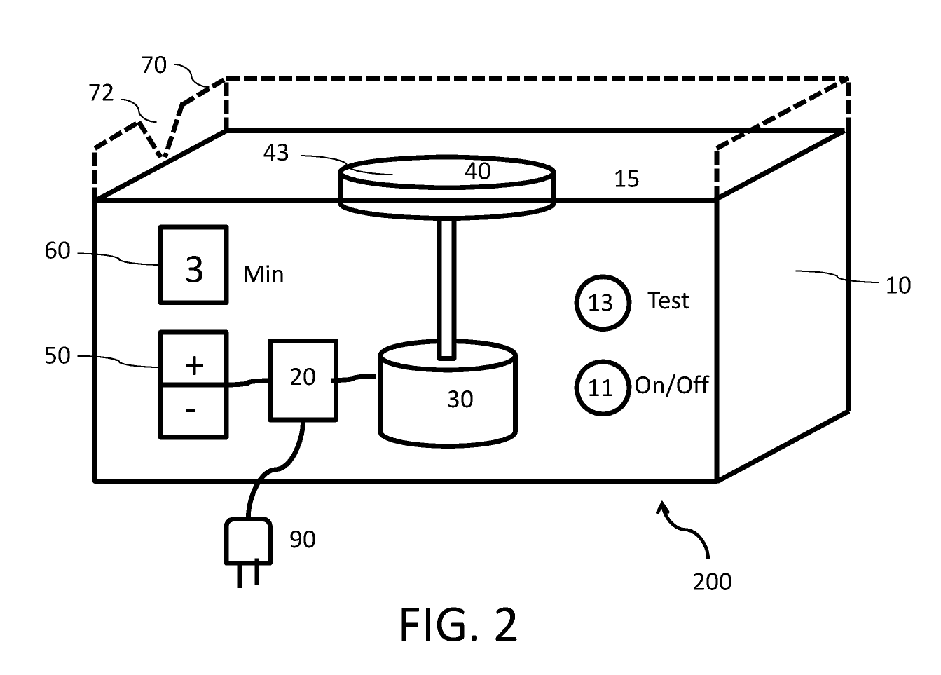

FIG. 2 is a diagram of an example implementation of a mouse moving device 200 described herein. The mouse moving device 200 is similar to the mouse moving device 100 of FIG. 1. except that the movable element 40 is a wheel having a top surface that is arranged level or approximately level with the top of the upper surface 15 of the housing 10. This will place the movable element 40 directly in contact with a computer mouse placed on the upper surface 15 of the housing 10.

The movable element 40 may include a textured pattern 43 that will allow the movable element to more easily move the track ball of a mechanical computer mouse. The movable element 40 may include a combination of a textured pattern 43 and a visual pattern 41.

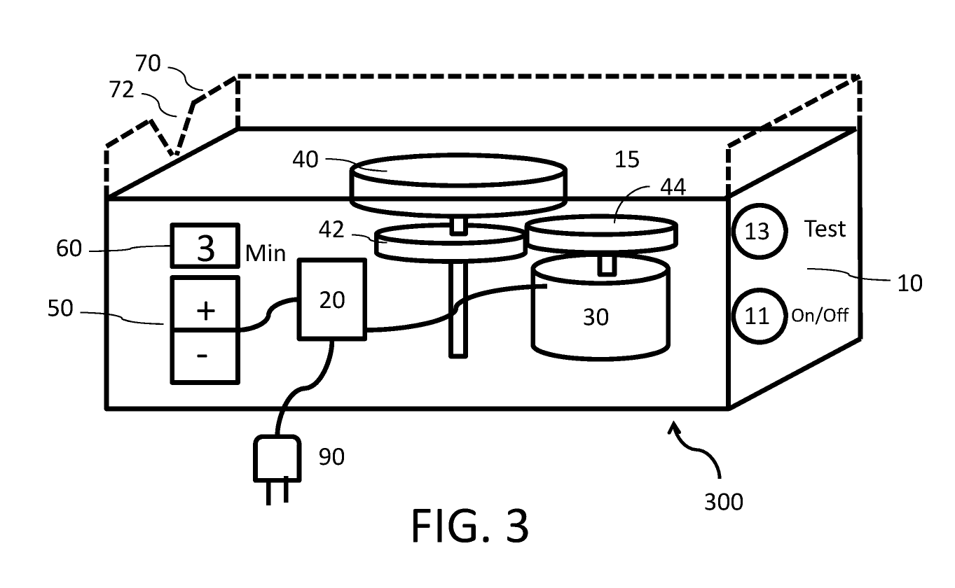

FIG. 3 is a diagram of an example implementation of a mouse moving device 300 described herein. The mouse moving device 300 is similar to the mouse moving device 200 of FIG. 2. except that the movable element 40 is a wheel having a number of gears 42, 44 arranged to couple the motor 30 to the movable element 40. This may allow the height of the housing 10 to be reduced for a slimmer mouse moving device 300 and/or may allow the speed of the movable element 40 to be geared differently from the speed of the motor 30.

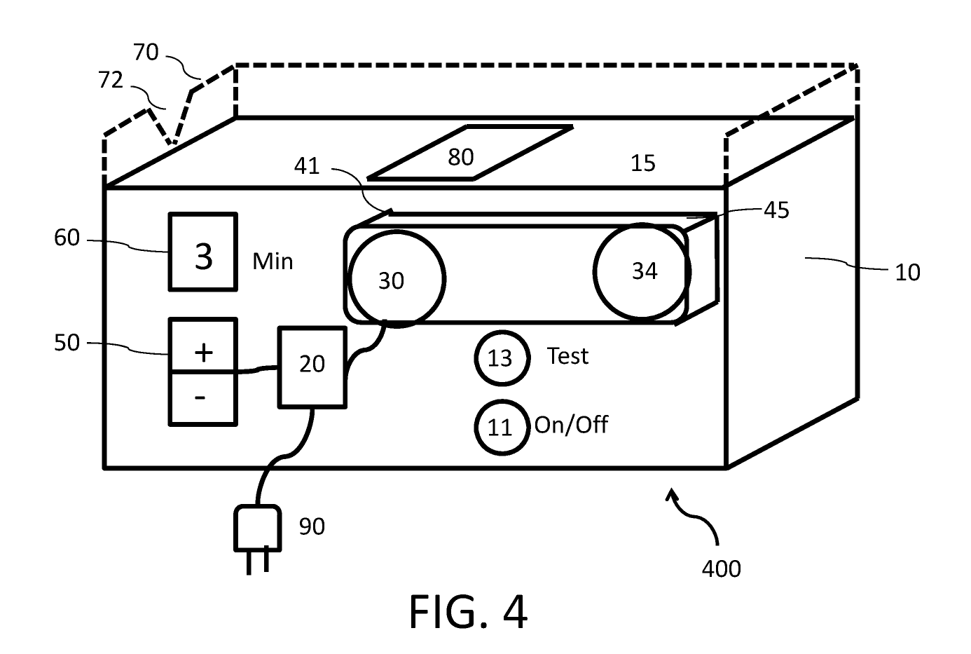

FIG. 4 is a diagram of an example implementation of a mouse moving device 400 described herein. As shown in FIG. 4, the mouse moving device 400 includes a housing 10 that includes an upper surface 15. The upper surface 15 has a size sufficient to support a computer mouse. The upper surface 15 may include a railing 70 for keeping a computer mouse in place on top of the upper surface 15. The railing 70 may completely surround the upper surface 15, although one side of the railing 70 has been omitted from the illustration shown in FIG. 4 for clarity. Alternatively, the railing may surround only portions of the upper surface 15. The railing 70 may include a cutout 72 to accommodate a cord of a computer mouse. The cord of a computer mouse may pass through the cutout 72 so that the computer mouse may sit flat on the upper surface 15.

The mouse moving device 400 includes a movable element 45. In the mouse moving device 400 of this example implementation, the movable element 45 is a belt. The movable element 45 includes a motor 30 and a wheel 34 that are arranged to drive the belt. The movable element 45 is arranged adjacent to the upper surface 15 and is visible through a window 80.

The movable element 45 is coupled to a motor 30 that moves the movable element 40. In one example, the motor 30 rotates the movable element 45. In another example, the motor 30 vibrates the movable element 45. In another example, the motor 30 moves the movable element 45 in one direction and then moves the movable element 45 in another direction. In another example, the motor 30 rotates the movable element 45 in one direction, for example, clockwise or counterclockwise, and then rotates the movable element 45 in the opposite direction.

The mouse moving device 400 may include a controller 20 that activates the motor 30 to move the movable element 45 at a recurring time interval. The controller 20 may move the movable element 45 for a predetermined time period and then stop moving the movable element 45, for example, the controller may move the movable element 45 for a predetermined time period of 1, 2, 3, 4, 5, 6, 7, 8, 9, or 10 seconds, or more. In one example, the controller 20 may cause the motor 30 to rotate the movable element 45 in a first direction for a first predetermined time period and then rotate the movable element 45 in a second direction for a second predetermined time period. The predetermined time periods may have the same or different durations. In one example, a user may be able to adjust the predetermined time period.

The mouse moving device 400 may include a control 50 for adjusting the length of the recurring time interval. For example, the control 50 may be used to program the controller 20 to adjust the number of minutes for the length of the time interval between when the motor 30 moves the movable element 45. The mouse moving device 400 may include a display 60 that displays the length of the recurring time interval. In one example, the length of the recurring time interval may be adjusted in minutes, for example, from between one minute to nine minutes. In another example, the length of the recurring time interval may be adjusted in minutes from between 1 and 60 minutes.

The mouse moving device 400 may include a testing control 13 for causing the motor 30 to activate the movable element 45 at a time other than the recurring time interval. This may allow a user to test that a computer mouse is properly seated on the mouse moving device 400 and give a user confidence that the mouse moving device 400 will move the computer mouse properly at the recurring time interval without waiting for that time interval to occur. The mouse moving device 400 may include an on/off switch 11 for turning the mouse moving device 400 on and off. In on example, the mouse moving device 400 may move the movable element 45 immediately upon being turned on and begin the recurring time intervals thereafter.

The movable element 45 may include a visual pattern 41 to ensure that an optical mouse will easily detect the movable element 45 when it is moving and cause the computer cursor to move. The visual pattern 41 may be a series of lines, a grid, a swirl, or other patterns. The visual pattern 41 may include high contrast colors that are easily detectable by an optical mouse.

The mouse moving device 400 includes a connection 90 to a power supply. The connection 90 may be a plug suitable for connecting to an electrical outlet to supply alternating current to the mouse moving device 400. The connection 90 may be a battery power supply located within the mouse moving device 400.

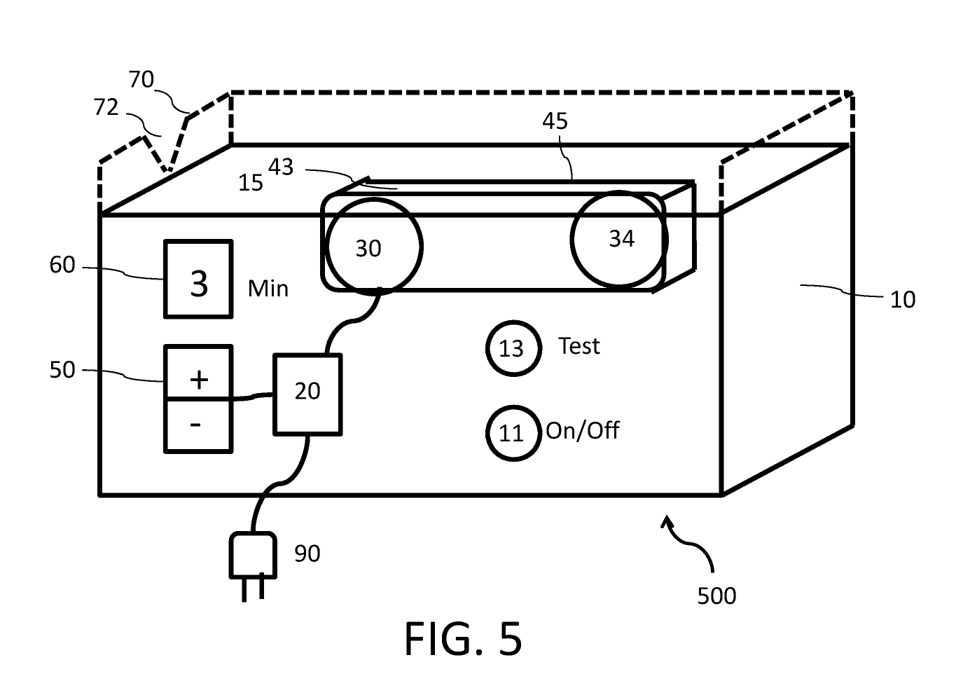

FIG. 5 is a diagram of an example implementation of a mouse moving device 500 described herein. The mouse moving device 500 is similar to the mouse moving device 400 of FIG. 4. except that the movable element 45 is a belt having a top surface that is arranged level or approximately level with the top of the upper surface 15 of the housing 10. This will place the movable element 45 directly in contact with a computer mouse placed on the upper surface 15 of the housing 10.

The movable element 45 may include a textured pattern 43 that will allow the movable element 45 to more easily move the track ball of a mechanical computer mouse. The movable element 45 may include a combination of a textured pattern 43 and a visual pattern 41.

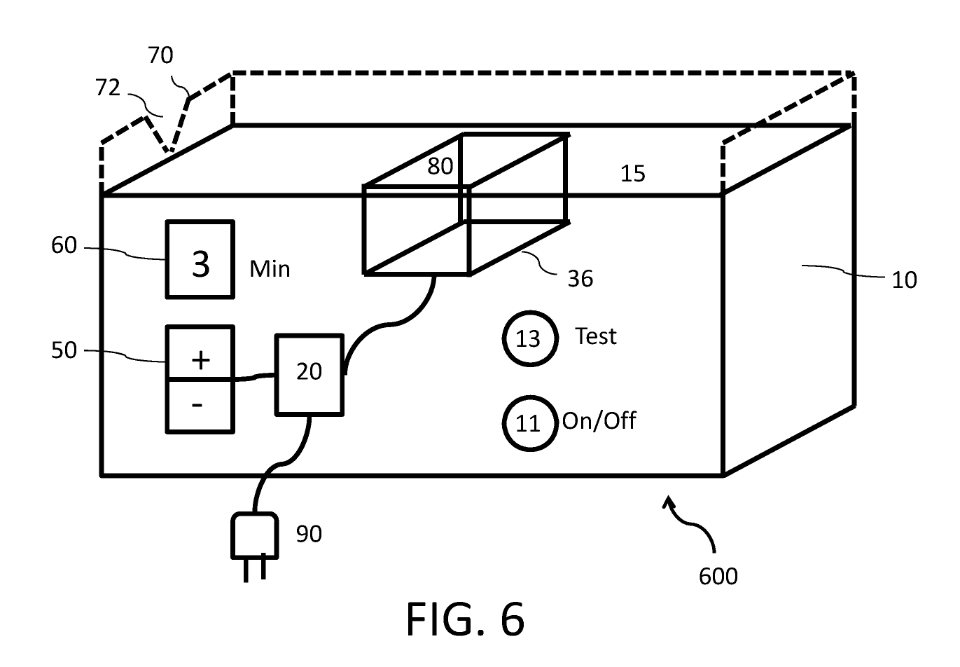

FIG. 6 is a diagram of an example implementation of a mouse moving device 600 described herein. The mouse moving device 600 includes a display element 80 arranged at the upper surface 15 of the housing 10. The controller 20 causes the display element 80 to display a moving visual pattern at a recurring time interval, which can in turn cause the motion sensor of an optical mouse to be activated, thereby moving a computer cursor. The display element 80 may be a liquid crystal display device or other type of display device. The moving visual pattern may be a pattern that will cause the motion sensor of an optical mouse to activate, and may include moving lines, swirls, grids, and the like.

To use the various mouse moving device examples described herein, a user will place a computer mouse onto the upper surface 15 of the housing 10. The user may turn on the mouse moving device using an on/off switch 11. The user may adjust the length of the recurring time interval at which the motor 30 moves the movable element 40 using the control. The length of the recurring time interval may be shorter than the time at which the user's computer will shut down, enter a sleep mode, and/or log out a user. The selected recurring time interval may be shown on the display 60. The controller 20 may then activate the motor 30 to move the movable element 40 at the recurring time interval to cause a motion sensing element on a computer mouse to detect motion and to move a cursor on the user's computer, thereby preventing the user's computer from shutting down, entering a sleep mode, and/or logging out the user, even though the user is not present at the computer during one or more recurring time intervals.

The foregoing disclosure provides illustration and description, but is not intended to be exhaustive or to limit the implementations to the precise form disclosed. Modifications and variations are possible in light of the above disclosure or may be acquired from practice of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms.

What is claimed is:

1. A computer mouse moving device, comprising:
a housing having an upper surface of a size sufficient to support a computer mouse;
a movable element adjacent to the upper surface;
a motor coupled to the movable element; and
a controller for activating the motor at a recurring time interval.

2. The computer mouse moving device of claim 1, further comprising a control for adjusting the length of the recurring time interval.

3. The computer mouse moving device of claim 2, further comprising a display that displays the length of the recurring time interval.

4. The computer mouse moving device of claim 1, further comprising a testing control for causing the motor to activate the movable element at a time other than the recurring time interval.

5. The computer mouse moving device of claim 1, wherein the movable element is a wheel.

6. The computer mouse moving device of claim 5, wherein a top surface of the wheel is level with the upper surface of the housing.

7. The computer mouse moving device of claim 1, wherein the movable element is a belt.

8. The computer mouse moving device of claim 1, further comprising a railing coupled to the upper surface of the housing.

9. The computer mouse moving device of claim 8, wherein the railing comprises a cutout to accommodate a cord of a computer mouse.

10. The computer mouse moving device of claim 1, wherein the movable element comprises a visual pattern.

11. The computer mouse moving device of claim 1, wherein the movable element comprises a textured pattern.

12. The computer mouse moving device of claim 1, wherein the upper surface of the housing comprises a window, and wherein the movable element is visible through the window.

13. The computer mouse moving device of claim 1, wherein the motor moves the movable element in a first direction and then in a second direction at the end of the recurring time interval.

14. The computer mouse moving device of claim 1, wherein the motor vibrates the movable element.

15. The computer mouse moving device of claim 1, wherein the motor turns the movable element.

16. The computer mouse moving device of claim 1, further comprising a battery power supply.

17. A method of moving a computer mouse, comprising:
placing the computer mouse onto an upper surface of a mouse moving device; and
activating a motor in the mouse moving device such that the motor moves a movable element adjacent to the upper surface to activate a motion sensor element on the computer mouse at a recurring time interval.

18. The method of claim 17, further comprising adjusting the length of the recurring time interval.

19. A computer mouse moving device, comprising:
a housing having an upper surface, wherein the upper surface is of a size sufficient to support a computer mouse;
a display element, adjacent to the upper surface; and
a controller coupled to the display element for causing the display element to display a moving visual pattern at a recurring time interval.

20. The computer mouse moving device of claim 19, further comprising a control for adjusting the length of the recurring time interval.
